(19) United States
(12) Patent Application Publication
(10) Pub. No.: US 2018/0020404 A1
(43) Pub. Date: Jan. 18, 2018

(54) WAKE-UP PACKET BACKOFF PROCEDURE

(71) Applicants: Po-Kai Huang, West Lafayette, IN (US); Minyoung Park, Portland, OR (US)

(72) Inventors: Po-Kai Huang, West Lafayette, IN (US); Minyoung Park, Portland, OR (US)

(21) Appl. No.: 15/391,606

(22) Filed: Dec. 27, 2016

Related U.S. Application Data
(60) Provisional application No. 62/362,173, filed on Jul. 14, 2016.

(51) Int. Cl. H04W 52/02; H04W 48/16; H04W 4/00; H04W 84/12; H04W 88/02

(52) U.S. Cl. CPC H04W 52/0229; H04W 48/16; H04W 4/008; H04W 88/02; H04W 84/12

(57) ABSTRACT

Embodiments of a LP-WUR (low-power wake-up radio) wake-up packet backoff procedure are generally described herein. A first wireless device initiates a backoff procedure to contend for a wireless medium for transmission of a wake-up packet of a first access category, the wake-up packet encoded to be received at a LP-WUR (low-power wake-up radio) of a second wireless device. The first wireless device determines that the wake-up packet is to be retransmitted based on a parameter of the backoff procedure, the parameter being independent of the first access category. The first wireless device encodes for retransmission of the wake-up packet of a second access category, each of the first access category and the second access category comprising a level of priority in EDCA (enhanced distributed channel access).

### PRIORITY CLAIM

This application claims priority under 35 U.S.C. §119 to U.S. Provisional Patent Application Ser. No. 62/362,173, filed Jul. 14, 2016, and titled, “LOW POWER WAKE UP RECEIVER (LP-WUR) BACKOFF PROCEDURE,” which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group. Some embodiments relate to a low-power wake-up radio (LP-WUR). Some embodiments relate to a wake-up packet backoff procedure.

### BACKGROUND

In recent years, applications have been developed relating to social networking, Internet of Things (IoT), wireless docking, and the like. It may be desirable to design low power solutions that can be always-on. However, constantly providing power to a wireless local area network (WLAN) radio may be expensive in terms of battery life.

### BRIEF DESCRIPTION OF THE DRAWINGS

FIG. 1 is a block diagram of a radio architecture, in accordance with some embodiments;

FIG. 2 illustrates a front-end module circuitry for use in the radio architecture of FIG. 1, in accordance with some embodiments;

FIG. 3 illustrates a radio IC circuitry for use in the radio architecture of FIG. 1, in accordance with some embodiments;

FIG. 4 illustrates a baseband processing circuitry for use in the radio architecture of FIG. 1, in accordance with some embodiments;

FIG. 5 illustrates an example system in which a low-power wake-up radio (LP-WUR) is operated, in accordance with some embodiments; and

FIG. 6 illustrates an example flow chart of an example method for wake-up packet backoff, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

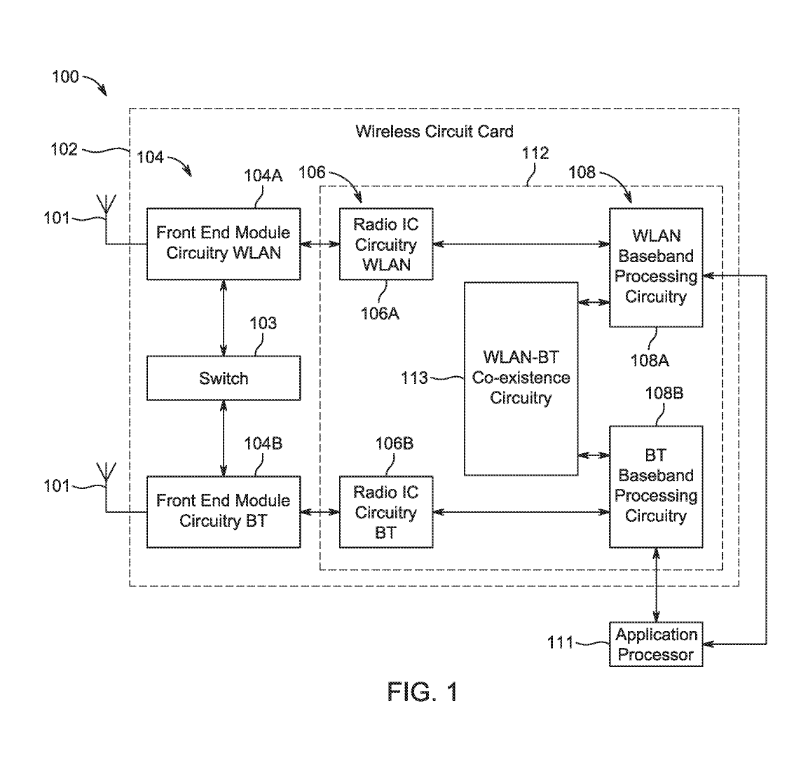

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104a and a Bluetooth (BT) FEM circuitry 104b. The WLAN FEM circuitry 104a may include a receive signal path comprising circuitry configured to operate on WLAN RF signals received from one or more antennas 101, to amplify the received signals and to provide the amplified versions of the received signals to the WLAN radio IC circuitry 106a for further processing. The BT FEM circuitry 104b may include a receive signal path which may include circuitry configured to operate on BT RF signals received from one or more antennas 102, to amplify the received signals and to provide the amplified versions of the received signals to the BT radio IC circuitry 106b for further processing. FEM circuitry 104a may also include a transmit signal path which may include circuitry configured to amplify WLAN signals provided by the radio IC circuitry 106a for wireless transmission by one or more of the antennas 101. In addition, FEM circuitry 104b may also include a transmit signal path which may include circuitry configured to amplify BT signals provided by the radio IC circuitry 106b for wireless transmission by the one or more antennas. In the embodiment of FIG. 1, although FEM 104a and FEM 104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106a and BT radio IC circuitry 106b. The WLAN radio IC circuitry 106a may include a receive signal path which may include circuitry to down-convert WLAN RF signals received from the FEM circuitry 104a and provide baseband signals to WLAN baseband processing circuitry 108a. BT radio IC circuitry 106b may in turn include a receive signal path which may include circuitry to down-convert BT RF signals received from the FEM circuitry 104b and provide baseband signals to BT baseband processing circuitry 108b. WLAN radio IC circuitry 106a may also include a transmit signal path which may include circuitry to up-convert WLAN baseband signals provided by the WLAN baseband processing circuitry 108a and provide WLAN RF output signals to the FEM circuitry 104a for subsequent wireless transmission by the one or more antennas 101. BT radio IC circuitry 106b may also include a transmit signal path which may include circuitry to up-convert BT baseband signals provided by the BT baseband processing circuitry 108b and provide BT RF output signals to the FEM circuitry 104b for subsequent wireless transmission by the one or more antennas 101. In the embodiment of FIG. 1, although radio IC circuitries 106a and 106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108a and a BT baseband processing circuitry 108b. The WLAN baseband processing circuitry 108a may include a memory, such as, for example, a set of RAM arrays in a Fast Fourier Transform or Inverse Fast Fourier Transform block (not shown) of the WLAN baseband processing circuitry 108a. Each of the WLAN baseband circuitry 108a and the BT baseband circuitry 108b may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108a and 108b may further include physical layer (PHY) and medium access control layer (MAC) circuitry, and may further interface with application processor 110 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108a and the BT baseband circuitry 108b to enable use cases requiring WLAN and BT coexistence. In addition, a switch 103 may be provided between the WLAN FEM circuitry 104a and the BT FEM circuitry 104b to allow switching between the WLAN and BT radios according to application needs. In addition, although the antennas 101 are depicted as being respectively connected to the WLAN FEM circuitry 104a and the BT FEM circuitry 104b, embodiments include within their scope the sharing of one or more antennas as between the WLAN and BT FEMs, or the provision of more than one antenna connected to each of FEM 104a or 104b.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11ac, and/or 802.11 ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108b may be compliant with a Bluetooth (BT) connectivity standard such as Bluetooth. Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

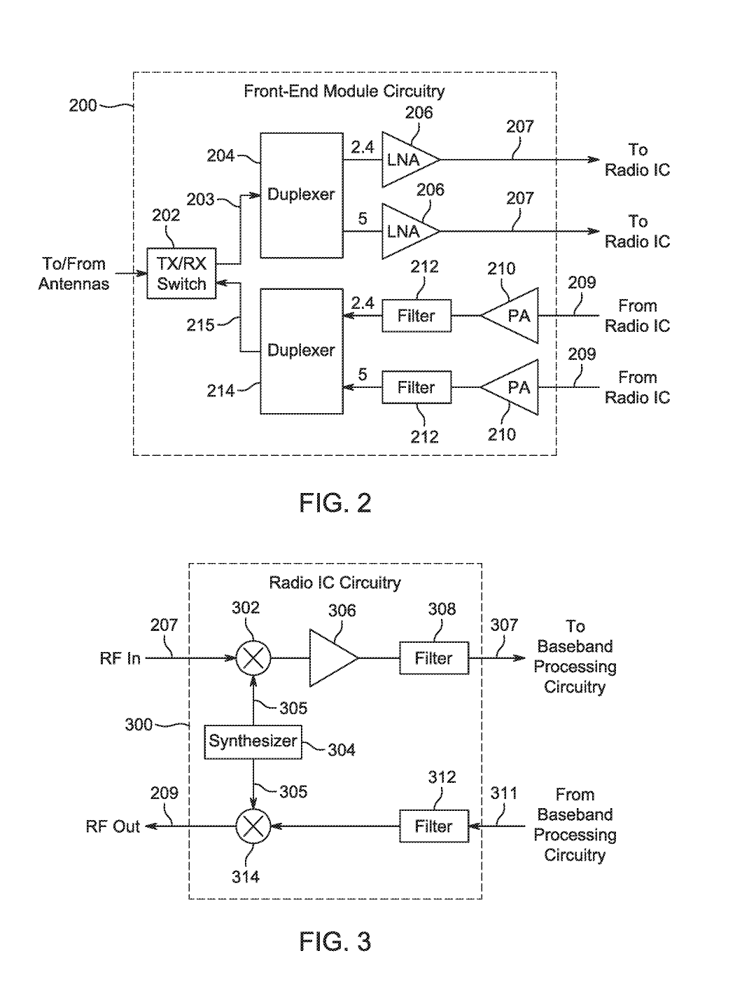

FIG. 2 illustrates FEM circuitry 200 in accordance with some embodiments. The FEM circuitry 200 is one example of circuitry that may be suitable for use as the WLAN and/or BT FEM circuitry 104a/104b (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

FIG. 3 illustrates radio IC circuitry 300 in accordance with some embodiments. The radio IC circuitry 300 is one example of circuitry that may be suitable for use as the WLAN or BT radio IC circuitry 106a/106b (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety degree time-varying LO switching signals provided by a quadrature circuitry which may be configured to receive a LO frequency (fLO) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 110 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 110.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (fLO).

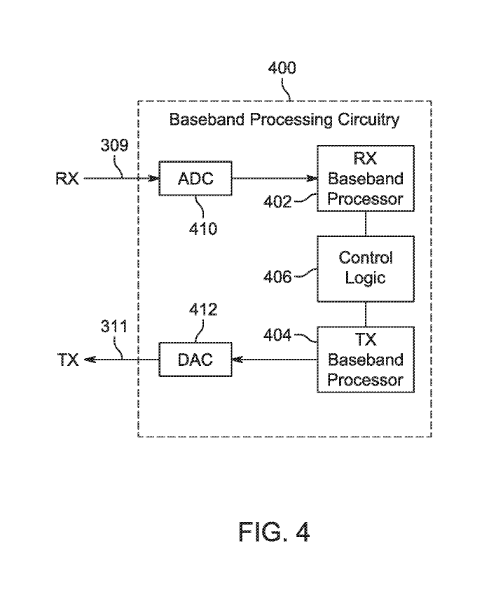

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108a, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

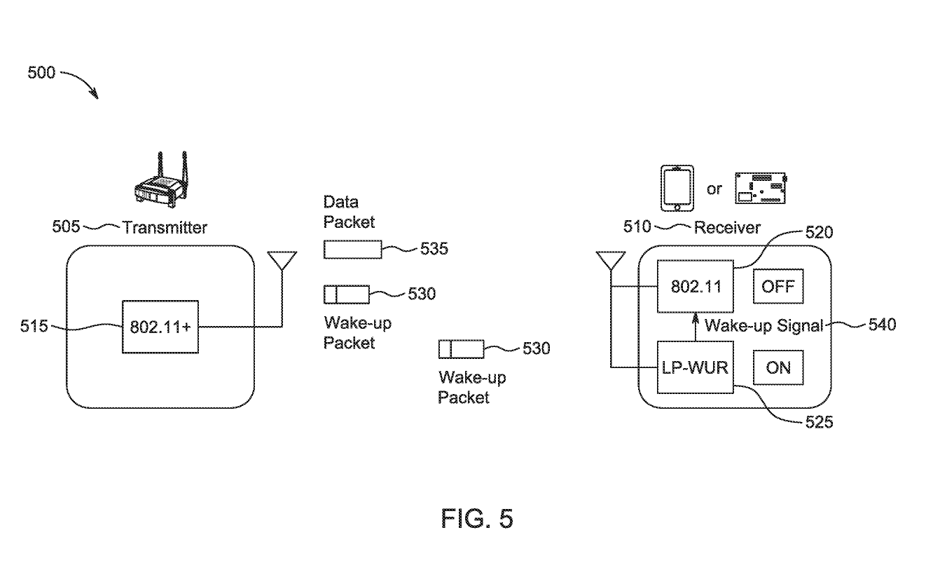

FIG. 5 illustrates an example system 500 in which a low-power wake-up radio is operated. As shown, the system 500 includes a transmitter 505 and a receiver 510. The transmitter 505 may be a WLAN station (e.g., Wi-Fi router) and the receiver 510 may be a computing device capable of connecting to the WLAN station, such as a mobile phone, a tablet computer, a laptop computer, a desktop computer, and the like. The transmitter 505 includes an WLAN (802.11+) radio 515. The receiver 510 includes a WLAN (802.11) radio 520 (e.g., Wi-Fi radio) and a LP-WUR 525. The WLAN radio 515 of the transmitter 505 transmits one or more wake-up packets 530. One of the wake-up packets 530 is received at the LP-WUR 525 of the receiver 510. Upon receiving the wake-up packet 530, the LP-WUR 525 sends a wake-up signal 540, which causes the WLAN radio 520 of the receiver 510 to turn on. The WLAN radio 515 of the transmitter 505 transmits data packet(s) 535 to the WLAN radio 520 of the receiver 510, and the WLAN radio 520 of the receiver 510 receives the data packet(s) 535.

As illustrated in FIG. 5, LP-WUR relates to a technique to enable ultra-low power operation for a Wi-Fi device (e.g., receiver 510). The idea is for the device to have a minimum radio configuration (e.g., LP-WUR 525) that can receive a wake-up packet 530 from the peer (e.g., transmitter 505). Hence, the device can stay in low power mode until receiving the wake-up packet 530.

The receiver 510 of the wake-up packet 530 may negotiate with the transmitter 505 of wake-up packet 530 before the receiver 510 enables the LP-WUR mode. Hence, the transmitter 505 knows the agreed bandwidth and channel in which to transmit the wake-up packet, the identification in the wake-up packet, and other related information. In some cases, the transmitter 505 may also send a response action frame with information to the receiver 510 before the receiver 510 enables the LP-WUR mode.

The receiver 510 of the wake-up packet 530 may inform the transmitter 505 of wake-up packet 530 before the receiver 510 enables the LP-WUR mode and turns off the WLAN radio 520. Hence, the transmitter 505 knows that wake-up packet 530 is allowed to transmit to the receiver 510. In some cases, the transmitter 505 may also send a response action frame with information to the receiver 510 before the receiver 510 enables the LP-WUR mode.

On the other hand, the transmitter 505 may be AP that regulates the power save operation in the base station subsystem (BSS). The receiver 510 may be a sensor, which has simple design and relies on AP to decide the power save mode. As a result, the AP may request the receiver 510 to enable or enable the LP-WUR mode, and the receiver 510 provides a response action frame accepting the request.

Since the wake-up packet 530 is transmitted by the WLAN radio 515 (e.g., an 802.11 radio), a backoff procedure may be used to transmit the wake-up packet 530. However, the current enhanced distributed channel access (EDCA) framework for transmitting WLAN/802.11 packets does not specify how to transmit the wake-up packet 530.

In some cases, it may be desirable to answer the following questions. What is the access category of the wake-up packet 530? What is the retransmission limit? How is the contention window updated based on the acknowledgement procedure?

According to some aspects, the subject technology allows a quality of service (QoS) station (STA) to use any access category to enable wake-up packet transmission. The reason is that the STA may need to send wake-up packet due to various reasons such as available packet for an access category to the other STA, a desire to wake up the other STA for an update, or a change the configuration of the base station subsystem (BSS). Hence, allowing any access category for transmission enables the full flexibility. However, once an access category is chosen for the wake-up packet and transmitted, the same access category is used for retransmission if needed. The access categories include: Background (AC_BK), Best Effort (AC_BE), Video (AC_VI), and Voice (AC_VO).

Similar to current 802.11 packets, in some embodiments, a retry counter is maintained for the wake-up packet 530. Furthermore, due to the possibility of a long acknowledgement time, the contention window is not updated due to failure of wake-up packet 530, if the acknowledgement procedure of wake-up packet 530 does not enable immediate response or if there is no acknowledgement procedure.

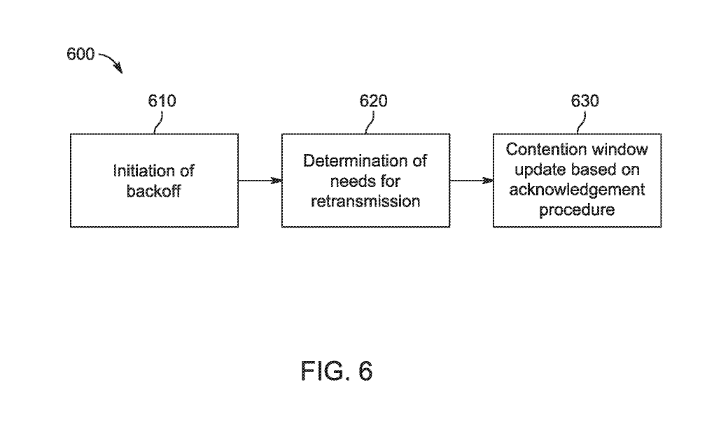

FIG. 6 illustrates an example flow chart of an example method 600 for wake-up packet backoff, in accordance with some embodiments. At operation 610, the backoff is initiated. At operation 620, needs for retransmission are determined. At operation 630, the contention window is updated based on the acknowledgement procedure. In some cases, one or more of the operations 610, 620, or 630 may be skipped. For example, if the acknowledgement procedure of wake-up packet 530 does not enable immediate response or if there is no acknowledgement procedure, the operation 630 may be skipped and only the operations 610 and 620 may be implemented.

At operation 610, for a transmitter 505 that implements the distributed coordination function (DCF), the transmitter 505 follows the current backoff procedure to contend the medium for transmitting the wake-up packet 530. For a QoS transmitter 505 that implements enhanced distributed channel access function (EDCAF), the transmitter 505 uses any access category to contend the medium and transmit the wake-up packet 530. The backoff procedure of the wake-up packet 530 then follows the backoff procedure defined in the 802.11 specification.

The transmitter 505 may transmit the wake-up packet 530 in a multi-user (MU) transmission, as defined in the 802.1 lax specification, along with other packets. In this case, the medium is grabbed by the other packets. The MU transmission may be orthogonal frequency division multiple access (OFDMA) or multi-user multiple-input multiple-output (MU-MIMO).

In another alternative, the transmitter 505 may transmit the wake-up packet in a transmission opportunity (TXOP) grabbed by other transmissions within the same access category or a lower access category as long as the TXOP limit is not violated.

At operation 620, according to some implementations, a retransmission counter is kept for each wake-up packet 530. The retransmission counter is increased by 1 when the wake-up packet is transmitted. There is no retransmission if the counter hits a retransmission limit and the packet is dropped. The retransmission counter may be a short retry count (SRC) or a long retry count (LRC). The determination of SRC or LRC status is based on the acknowledgement procedure, in other words, retransmit the wake-up packet 530 if no acknowledgement is received, at the transmitter 505, from the receiver 510 of the wake-up packet 530. If there are no acknowledgement procedure for the wake-up packet, the transmitter 505 can simply retransmit the wake-up packet 530 for a certain number of time, then stop the transmissions.

In some cases, the time for retransmission depends on the acknowledgement procedure. The transmitter 505 may retransmit another wake-up packet 530 within the short interframe space (SIFS) of the previous wake-up packet 530 if there are no acknowledgement procedure as long as the same access category of the previous wake-up packet 530 is used, and the TXOP limit of the access category is not violated. If there is an acknowledgement procedure, the transmitter 505 retransmits the wake-up packet 530 after identifying no response from the receiver 510.

If there is an acknowledgement procedure, then the transmitter 505 may initiate another transmission to retransmit another wake-up packet 530 after identifying transmission failure from the intended receiver of the wake-up packet. A timer is kept to identify no acknowledgement. If there is no frame that is sent back from the intended receiver 510 of the wake-up packet 530 within the duration of the timer to acknowledge the reception of the wake-up packet 530, then a transmission failure is identified, and the transmitter 505 may retransmit the wake-up packet 530 after identifying transmission failure.

If there is an acknowledgement procedure and immediate response is enabled, then a TXOP may be granted when receiving the immediate response correctly. The transmitter 505 may transmit other packets with the same access category in the same TXOP. The access category of the retransmitted wake-up packet 530 is the same as the access category used to transmit the wake-up packet 530 for the first time.

In some embodiments, a wake up packet lifetime timer is kept for each wake up packet 530. The wake-up packet 530 is transmitted only if the lifetime timer of the wake-up packet 530 has not expired. If the lifetime timer of a wake-up packet 530 expires, then the wake-up packet 530 is not retransmitted. The lifetime timer of the wake-up packet 530 starts when the wake-up packet 530 is generated in the media access control (MAC) to contend for the medium. A default maximum value for the lifetime timer is specified in the specification for the wake-up packet 530. This is similar to the MAC service data unit (MSDU) timer defined in the current 802.11 specification.

In some cases. A QoS STA maintains a transmit MSDU timer for each MSDU passed to the MAC. A variable called dot11EDCATableMSDULifetime specifies the maximum amount of time allowed to transmit an MSDU for a given AC. The transmit MSDU timer is started when the MSDU is passed to the MAC. If the value of this timer exceeds the appropriate entry in dot11EDCATableMSDULifetime, then the MSDU, or any remaining, undelivered fragments of that MSDU, is discarded by the source STA without any further attempt to complete delivery of that MSDU.

At operation 630, if the acknowledgement procedure enables immediate response from the receiver 510 of the wake-up packet 530, the transmitter 505 updates the contention window based on exponential backoff defined in 802.11 specification. This may include for example, updating contention window (CW) under DCF, updating CW[AC] under EDCAF, updating station SRC (SSRC) or station LRC (SLRC) under DCF, or updating QoS SRC[AC] (QSRC[AC]) or QoS LRC[AC] (QLRC[AC]) under EDCAF. The immediate response may be sent under LP-WUR mode or with the WLAN (e.g., 802.11) radio 520 of the receiver 510.

In some cases, the acknowledgement procedure does not enable immediate response from the receiver 510 of the wake-up packet 530. In other words, the response only happens when the receiver 510 fully wakes up its own WLAN radio 520. In these cases, the transmitter 505 does not update the contention window and does not update the retry count used to update the contention window. For example, the transmitter 505 does not update CW, SSRC, or SLRC under DCF and does not update CW[AC], or QSRC[AC], or QLRC[AC] under EDCAF.

In some cases, there is no acknowledgement procedure. In these cases, the transmitter 505 does not update any contention window and does not update any retry count used to update the contention window. For example, the transmitter 505 does not update CW, SSRC, or SLRC under DCF and does not update CW[AC], or QSRC[AC], or QLRC[AC] under EDCAF.

Aspects of the subject technology are described below using various examples.

Example 1 is an apparatus of a first wireless device, the apparatus comprising: memory; and processing circuitry, the processing circuitry to: initiate a backoff procedure to contend for a wireless medium for transmission of a wake-up packet of a first access category, the wake-up packet encoded to be received at a LP-WUR (low-power wake-up radio) of a second wireless device; determine that the wake-up packet is to be retransmitted based on a parameter of the backoff procedure, the parameter being independent of the first access category; and encode for retransmission of the wake-up packet of a second access category, each of the first access category and the second access category comprising a level of priority in EDCA (enhanced distributed channel access).

Example 2 is the apparatus of example 1, wherein the first access category is different from the second access category.

Example 3 is the apparatus of example 1, wherein the first access category is identical to the second access category.

Example 4 is the apparatus of example 1, wherein each of the first access category and the second access category comprises one of: Background (AC_BK), Best Effort (AC_BE), Video (AC_VI), and Voice (AC_VO), and wherein each of the first access category and the second access category is selected based on contention in at least one of AC_BK, AC_BE, AC_VI, and AC_VO.

Example 5 is the apparatus of example 1, wherein the parameter comprises a retransmission counter of the wake-up packet, and wherein the processing circuitry to determine that the wake-up packet is to be retransmitted is to: increase a retransmission counter by one when the wake-up packet is retransmitted; and determine that the wake-up packet is to be retransmitted based on the retransmission counter being below a retransmission limit value.

Example 6 is the apparatus of example 1, wherein the parameter comprises a lifetime timer of the wake-up packet, the processing circuitry to encode for retransmission of the wake-up packet responsive to a current time being before an expiration of the lifetime timer.

Example 7 is the apparatus of example 1, wherein the processing circuitry is to encode for transmission of the wake-up packet in a MU (multi-user) transmission, and wherein the MU transmission comprises an OFDMA (orthogonal frequency division multiple access) or MU-MIMO (multiple-input multiple-output) transmission.

Example 8 is the apparatus of example 1, wherein an acknowledgement procedure enables immediate response to the wake-up packet from the second wireless device to the first wireless device, the immediate response being transmitted by the LP-WUR or the WLAN radio of the second wireless device, and wherein the processing circuitry is further to: update a CW (contention window) based on exponential backoff; wherein the processing circuitry, to update the CW, is to one or more of: update the CW under DCF (distributed coordination function); update the CW access category under EDCAF (enhanced distributed channel access function); update SSRC (station short retry count) or SLRC (station long retry count) under DCF; and update QSRC (quality of service short retry count) access category or QLRC (quality of service long retry count) under EDCAF.

Example 9 is the apparatus of example 1, wherein an acknowledgement procedure does not enable immediate response to the wake-up packet from the second wireless device to the first wireless device, and wherein the processing circuitry is further to: forego updating a contention window associated with each level of priority in EDCA; and forego updating a retry count used to update the contention window.

Example 10 is the apparatus of example 1, wherein the second wireless device foregoes providing an acknowledgement of receipt of the wake-up packet to the first wireless device, and wherein the processing circuitry is further to: forego updating a contention window associated with each level of priority in EDCA; and forego updating a retry count used to update the contention window.

Example 11 is the apparatus of example 1, further comprising transceiver circuitry to: transmit the wake-up packet.

Example 12 is the apparatus of example 11, further comprising an antenna coupled with the transceiver circuitry.

Example 13 is a non-transitory machine-readable medium storing instructions for execution by processing circuitry of a first wireless device, the instructions causing the processing circuitry to: initiate a backoff procedure to contend for a wireless medium for transmission of a wake-up packet of a first access category, the wake-up packet encoded to be received at a LP-WUR (low-power wake-up radio) of a second wireless device; determine that the wake-up packet is to be retransmitted based on a parameter of the backoff procedure, the parameter being independent of the first access category; and encode for retransmission of the wake-up packet of a second access category, each of the first access category and the second access category comprising a level of priority in EDCA (enhanced distributed channel access).

Example 14 is the machine-readable medium of example 13, wherein the first access category is different from the second access category.

Example 15 is the machine-readable medium of example 13, wherein the first access category is identical to the second access category.

Example 16 is the machine-readable medium of example 13, wherein each of the first access category and the second access category comprises one of: Background (AC_BK), Best Effort (AC_BE), Video (AC_VI), and Voice (AC_VO), and wherein each of the first access category and the second access category is selected based on contention in at least one of AC_BK, AC_BE, AC_VI, and AC_VO.

Example 17 is the machine-readable medium of example 13, wherein the parameter comprises a retransmission counter of the wake-up packet, and wherein the processing circuitry to determine that the wake-up packet is to be retransmitted is to: increase a retransmission counter by one when the wake-up packet is retransmitted; and determine that the wake-up packet is to be retransmitted based on the retransmission counter being below a retransmission limit value.

Example 18 is the machine-readable medium of example 13, wherein the parameter comprises a lifetime timer of the wake-up packet, the processing circuitry to encode for retransmission of the wake-up packet responsive to a current time being before an expiration of the lifetime timer.

Example 19 is the machine-readable medium of example 13, wherein the processing circuitry is to encode for transmission of the wake-up packet in a MU (multi-user) transmission, and wherein the MU transmission comprises an OFDMA (orthogonal frequency division multiple access) or MU-MIMO (multiple-input multiple-output) transmission.

Example 20 is the machine-readable medium of example 13, wherein an acknowledgement procedure enables immediate response to the wake-up packet from the second wireless device to the first wireless device, the immediate response being transmitted by the LP-WUR or the WLAN radio of the second wireless device, and wherein the processing circuitry is further to: update a CW (contention window) based on exponential backoff; wherein the processing circuitry, to update the CW, is to one or more of: update the CW under DCF (distributed coordination function); update the CW access category under EDCAF (enhanced distributed channel access function); update SSRC (station short retry count) or SLRC (station long retry count) under DCF; and update QSRC (quality of service short retry count) access category or QLRC (quality of service long retry count) under EDCAF.

Example 21 is the machine-readable medium of example 13, wherein an acknowledgement procedure does not enable immediate response to the wake-up packet from the second wireless device to the first wireless device, and wherein the processing circuitry is further to: forego updating a contention window associated with each level of priority in EDCA; and forego updating a retry count used to update the contention window.

Example 22 is the machine-readable medium of example 13, wherein the second wireless device foregoes providing an acknowledgement of receipt of the wake-up packet to the first wireless device, and wherein the processing circuitry is further to: forego updating a contention window associated with each level of priority in EDCA; and forego updating a retry count used to update the contention window.

Example 23 is a method, implemented at a first wireless device, the method comprising: initiating a backoff procedure to contend for a wireless medium for transmission of a wake-up packet of a first access category, the wake-up packet encoded to be received at a LP-WUR (low-power wake-up radio) of a second wireless device; determining that the wake-up packet is to be retransmitted based on a parameter of the backoff procedure, the parameter being independent of the first access category; and encoding for retransmission of the wake-up packet of a second access category, each of the first access category and the second access category comprising a level of priority in EDCA (enhanced distributed channel access).

Example 24 is the method of example 23, wherein the parameter comprises a retransmission counter of the wake-up packet, and wherein determining that the wake-up packet is to be retransmitted comprises: increasing a retransmission counter by one when the wake-up packet is retransmitted; and determining that the wake-up packet is to be retransmitted based on the retransmission counter being below a retransmission limit value.

Example 25 is the method of example 23, wherein the parameter comprises a lifetime timer of the wake-up packet, the method comprising encoding for retransmission of the wake-up packet responsive to a current time being before an expiration of the lifetime timer.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a first wireless device, the apparatus comprising:
memory; and processing circuitry, the processing circuitry to:
initiate a backoff procedure to contend for a wireless medium for transmission of a wake-up packet of a first access category, the wake-up packet encoded to be received at a LP-WUR (low-power wake-up radio) of a second wireless device;
determine that the wake-up packet is to be retransmitted based on a parameter of the backoff procedure, the parameter being independent of the first access category; and
encode for retransmission of the wake-up packet of a second access category, each of the first access category and the second access category comprising a level of priority in EDCA (enhanced distributed channel access).

2. The apparatus of claim 1, wherein the first access category is different from the second access category.

3. The apparatus of claim 1, wherein the first access category is identical to the second access category.

4. The apparatus of claim 1, wherein each of the first access category and the second access category comprises one of: Background (AC_BK), Best Effort (AC_BE), Video (AC_VI), and Voice (AC_VO), and wherein each of the first access category and the second access category is selected based on contention in at least one of AC_BK, AC_BE, AC_VI, and AC_VO.

5. The apparatus of claim 1, wherein the parameter comprises a retransmission counter of the wake-up packet, and wherein the processing circuitry to determine that the wake-up packet is to be retransmitted is to:
increase a retransmission counter by one when the wake-up packet is retransmitted; and
determine that the wake-up packet is to be retransmitted based on the retransmission counter being below a retransmission limit value.

6. The apparatus of claim 1, wherein the parameter comprises a lifetime timer of the wake-up packet, the processing circuitry to encode for retransmission of the wake-up packet responsive to a current time being before an expiration of the lifetime timer.

7. The apparatus of claim 1, wherein the processing circuitry is to encode for transmission of the wake-up packet in a MU (multi-user) transmission, and wherein the MU transmission comprises an OFDMA (orthogonal frequency division multiple access) or MU-MIMO (multiple-input multiple-output) transmission.

8. The apparatus of claim 1, wherein an acknowledgement procedure enables immediate response to the wake-up packet from the second wireless device to the first wireless device, the immediate response being transmitted by the LP-WUR or the WLAN radio of the second wireless device, and wherein the processing circuitry is further to:
update a CW (contention window) based on exponential backoff;
wherein the processing circuitry, to update the CW, is to one or more of:
update the CW under DCF (distributed coordination function);
update the CW access category under EDCAF (enhanced distributed channel access function);
update SSRC (station short retry count) or SLRC (station long retry count) under DCF; and
update QSRC (quality of service short retry count) access category or QLRC (quality of service long retry count) under EDCAF.

9. The apparatus of claim 1, wherein an acknowledgement procedure does not enable immediate response to the wake-up packet from the second wireless device to the first wireless device, and wherein the processing circuitry is further to:
forego updating a contention window associated with each level of priority in EDCA; and
forego updating a retry count used to update the contention window.

10. The apparatus of claim 1, wherein the second wireless device foregoes providing an acknowledgement of receipt of the wake-up packet to the first wireless device, and wherein the processing circuitry is further to:
forego updating a contention window associated with each level of priority in EDCA; and
forego updating a retry count used to update the contention window.

11. The apparatus of claim 1, further comprising transceiver circuitry to:
transmit the wake-up packet.

12. The apparatus of claim 11, further comprising an antenna coupled with the transceiver circuitry.

13. A non-transitory machine-readable medium storing instructions for execution by processing circuitry of a first wireless device, the instructions causing the processing circuitry to:
initiate a backoff procedure to contend for a wireless medium for transmission of a wake-up packet of a first access category, the wake-up packet encoded to be received at a LP-WUR (low-power wake-up radio) of a second wireless device;
determine that the wake-up packet is to be retransmitted based on a parameter of the backoff procedure, the parameter being independent of the first access category; and
encode for retransmission of the wake-up packet of a second access category, each of the first access category and the second access category comprising a level of priority in EDCA (enhanced distributed channel access).

14. The machine-readable medium of claim 13, wherein the first access category is different from the second access category.

15. The machine-readable medium of claim 13, wherein the first access category is identical to the second access category.

16. The machine-readable medium of claim 13, wherein each of the first access category and the second access category comprises one of: Background (AC_BK), Best Effort (AC_BE), Video (AC_VI), and Voice (AC_VO), and wherein each of the first access category and the second access category is selected based on contention in at least one of AC_BK, AC_BE, AC_VI, and AC_VO.

17. The machine-readable medium of claim 13, wherein the parameter comprises a retransmission counter of the wake-up packet, and wherein the processing circuitry to determine that the wake-up packet is to be retransmitted is to:
increase a retransmission counter by one when the wake-up packet is retransmitted; and
determine that the wake-up packet is to be retransmitted based on the retransmission counter being below a retransmission limit value.

18. The machine-readable medium of claim 13, wherein the parameter comprises a lifetime timer of the wake-up packet, the processing circuitry to encode for retransmission of the wake-up packet responsive to a current time being before an expiration of the lifetime timer.

19. The machine-readable medium of claim 13, wherein the processing circuitry is to encode for transmission of the wake-up packet in a MU (multi-user) transmission, and wherein the MU transmission comprises an OFDMA (orthogonal frequency division multiple access) or MU-MIMO (multiple-input multiple-output) transmission.

20. The machine-readable medium of claim 13, wherein an acknowledgement procedure enables immediate response to the wake-up packet from the second wireless device to the first wireless device, the immediate response being transmitted by the LP-WUR or the WLAN radio of the second wireless device, and wherein the processing circuitry is further to:
update a CW (contention window) based on exponential backoff;
wherein the processing circuitry, to update the CW, is to one or more of:
update the CW under DCF (distributed coordination function);
update the CW access category under EDCAF (enhanced distributed channel access function);
update SSRC (station short retry count) or SLRC (station long retry count) under DCF; and
update QSRC (quality of service short retry count) access category or QLRC (quality of service long retry count) under EDCAF.

21. The machine-readable medium of claim 13, wherein an acknowledgement procedure does not enable immediate response to the wake-up packet from the second wireless device to the first wireless device, and wherein the processing circuitry is further to:
forego updating a contention window associated with each level of priority in EDCA; and
forego updating a retry count used to update the contention window.

22. The machine-readable medium of claim 13, wherein the second wireless device foregoes providing an acknowledgement of receipt of the wake-up packet to the first wireless device, and wherein the processing circuitry is further to:
forego updating a contention window associated with each level of priority in EDCA; and
forego updating a retry count used to update the contention window.

23. A method, implemented at a first wireless device, the method comprising:
initiating a backoff procedure to contend for a wireless medium for transmission of a wake-up packet of a first access category, the wake-up packet encoded to be received at a LP-WUR (low-power wake-up radio) of a second wireless device;
determining that the wake-up packet is to be retransmitted based on a parameter of the backoff procedure, the parameter being independent of the first access category; and
encoding for retransmission of the wake-up packet of a second access category, each of the first access category and the second access category comprising a level of priority in EDCA (enhanced distributed channel access).

24. The method of claim 23, wherein the parameter comprises a retransmission counter of the wake-up packet, and wherein determining that the wake-up packet is to be retransmitted comprises:
increasing a retransmission counter by one when the wake-up packet is retransmitted; and
determining that the wake-up packet is to be retransmitted based on the retransmission counter being below a retransmission limit value.

25. The method of claim 23, wherein the parameter comprises a lifetime timer of the wake-up packet, the method comprising encoding for retransmission of the wake-up packet responsive to a current time being before an expiration of the lifetime timer.
